(19) United States
(12) Patent Application Publication
(10) Pub. No.: US 2025/0127297 A1
(43) Pub. Date: Apr. 24, 2025

(54) MOBILE RACKS FOR A KITCHEN ENVIRONMENT

(71) Applicant: LAB2FAB LLC, Fremont, CA (US)

(72) Inventor: John Paul Norman, San Jose, CA (US)

(21) Appl. No.: 18/920,040

(22) Filed: Oct. 18, 2024

Related U.S. Application Data
(60) Provisional application No. 63/591,329, filed on Oct. 18, 2023.

(51) Int. Cl. A47B 77/16; A47B 77/02; A47B 96/06

(52) U.S. Cl. CPC A47B 77/16; A47B 77/02; A47B 96/06

(57) ABSTRACT

Example systems and methods for storing food items may include a frame for retaining mobile racks having multiple bays. The frame includes a plurality of docks configured to guide one of the mobile racks to a storage position in the dock. The frame also includes a lock configured to selectively prevent movement of the mobile rack in the storage position. Additionally, the frame includes a plurality of bay sensors for each dock. The bay sensors are configured to detect a presence of a food ingredient stored in the bays of the mobile rack when the mobile rack is in the storage position.

### CROSS-REFERENCE TO RELATED APPLICATIONS

This application claims the benefit of U.S. Provisional Patent Application No. 63/591,329, filed Oct. 18, 2023, the disclosure of which is hereby incorporated by reference herein in its entirety for all purposes.

### INTRODUCTION

The present disclosure is directed to automated kitchen equipment, and more particularly, to a system for storing food items.

### BACKGROUND

Systems have been developed for automated production of pizza and other food products. Merely as examples, automated food (e.g., pizza) production systems and method are known from U.S. Provisional Patent Application No. 62/819,326 (filed on Mar. 15, 2019), U.S. patent application Ser. No. 16/780,797 (filed on Feb. 3, 2020), U.S. patent application Ser. No. 17/885,093 (filed on Aug. 10, 2022), and U.S. patent application Ser. No. 17/885,104 (filed on Aug. 10, 2022), each of which are hereby incorporated by reference in their entireties for all purposes.

It is desired to enhance existing automated food production systems and methods by automating associated systems and methods. For example, it is desired to automate aspects of the temporary storage of food ingredients, e.g., unbaked pizza dough or unbaked assembled pizzas, or of completed food items, e.g., a baked pizza.

### SUMMARY

In at least some example approaches, a storage system comprises a plurality of mobile racks, with each rack having a plurality of bays. The storage system also include a frame comprising a plurality of docks configured to guide one of the mobile racks to a storage position in the dock. The frame also includes a lock configured to selectively prevent movement of the mobile rack in the storage position. The frame also includes a plurality of bay sensors for each dock. The bay sensors are configured to detect a presence of a food ingredient stored in the bays of the mobile rack when the mobile rack is in the storage position.

In at least some example approaches, a frame is provided for retaining mobile racks having multiple bays. The frame includes a plurality of docks configured to guide one of the mobile racks to a storage position in the dock. The frame also includes a lock configured to selectively prevent movement of the mobile rack in the storage position. Additionally, the frame includes a plurality of bay sensors for each dock. The bay sensors are configured to detect a presence of a food ingredient stored in the bays of the mobile rack when the mobile rack is in the storage position.

In at least some example approaches, a method of storing food ingredients comprises providing a plurality of mobile racks, the racks each comprising a plurality of bays. The method further includes detecting a location of one of the mobile racks in a storage position of a frame. The frame comprises a plurality of docks, each configured to guide the one of the mobile racks to the storage position in the dock. The frame also includes a lock configured to selectively prevent movement of the one of the mobile racks in the storage position. Additionally, the frame includes a plurality of bay sensors for each dock. The bay sensors are configured to detect a presence of a food ingredient stored in the bays of the mobile rack when the mobile rack is in the storage position.

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1A depicts a perspective view of a storage system for food items having a frame and a plurality of mobile racks, with the storage racks moved away from the frame, in accordance with some embodiments of the disclosure;

FIG. 1B depicts a perspective view of the storage system of FIG. 1B, with the mobile racks in a storage position relative to the frame, in accordance with some embodiments of the disclosure;

FIG. 2 depicts a perspective view of the frame of the storage system of FIGS. 1A and 1B, in accordance with some embodiments of the disclosure;

FIG. 3 depicts a perspective view of a mobile rack of the storage system of FIGS. 1A and 1B, in accordance with some embodiments of the disclosure; and

FIG. 4 depicts a perspective view of an automated food system that includes the storage system of FIGS. 1A and 1B, in accordance with some embodiments of the disclosure; and

FIG. 5 is a flow chart representing an illustrative method of storing food items, in accordance with some embodiments of the disclosure.

### DETAILED DESCRIPTION

Example illustrations herein are directed to storage systems that may be utilized in automated food systems, such as in a commercial kitchen. Generally, mobile or moveable racks may streamline food assembly and baking processes. For example, a plurality of mobile automated racks may be configured to work in conjunction with systems directed to assembly and/or baking of pizzas. These racks may store food items or ingredients and may facilitate efficient workflow and food safety. The racks may interface with a stationary frame that can support or house essential electrical components and systems. Mobile racks may thereby be integrated into automated processes, enhancing operational efficiency in busy kitchen environments.

Generally, a mobile rack may be equipped with one or more locating features designed to ensure alignment and placement within a frame. These locating features may facilitate consistency and reliability in the operation of the system, preventing misalignment during docking and ensuring that the racks are correctly positioned for effective interaction with the stationary frame.

Integrated feedback devices may also facilitate a secure connection of the mobile racks to a frame, e.g., by confirming whether the rack is docked correctly within the frame or otherwise communicating a location of the rack. This feedback may help kitchen staff confirm secure positioning of the rack, and to quickly identify any issues that may arise during the operation, ensuring that workflow remains uninterrupted.

The rack and/or the frame may include one or more sensors configured to detect a presence of a dough or other food item that is stored in the rack(s) and is intended to be processed in an automated food system, e.g., directed to assembly and/or baking of pizzas. These sensors may ensure consistent inventory of the contents of the mobile racks. By monitoring inventory in real time, kitchen operators can make informed decisions about food preparation and storage, reducing waste and thereby improving productivity.

Mobile racks in the examples herein may be equipped with an identification tag, such as a radio frequency identification (RFID) tag or chip. The tags or chips may provide information about the rack itself, including its contents and location. Additionally, to the extent an identification tag is remotely trackable, a status and location of each rack may be known by a controller or other components of a kitchen system, regardless of whether/where the mobile rack is docked with the frame. Accordingly, the identification tag may enhance inventory management and aid in maintaining organization within the kitchen.

In examples below, mobile racks are unpowered and do not carry batteries or on-rack power supply. In some examples, mobile racks carry passive devices that facilitate sensing by powered components of other components of a food storage system, such as reflectors or the like that facilitate detection of a presence of item(s) in bay(s) of the racks. In other examples, mobile racks may have electronic equipment such as sensors that are powered via a plug or other device of the rack that interfaces with a receptacle or power source of the frame, e.g., when the rack is docked with the frame. A plug/receptable may streamline a connection process, ensuring that powered components of the rack are automatically energized when in place, reducing the complexity of setup and enhancing usability. In still other approaches, a rack may carry a battery or other power source with the rack, e.g., to power sensors, communication devices, etc. of the rack.

Generally, storage racks may be employed to store food ingredients such as or baked/completed food items. Merely by way of example, in an automated kitchen or system for making pizza, an unbaked pizza dough may be flattened and placed upon a pizza pan (either with or without toppings such as sauce, cheese, pepperoni, etc.) in advance of an order or otherwise before there is a need to prepare and/or bake the pizza. The pizza/dough may in these cases be temporarily held, e.g., in a refrigerated or otherwise relatively cold or climate-controlled environment, until there is a need to prepare a pizza (e.g., apply toppings) and/or bake the pizza/dough.

In an example kitchen environment, it may be desired to provide mobile or mobile racks, which may be moved as needed. For example, a rack having a number of separate trays or bays might be filled with unprepared and/or unbaked doughs/assembled pizzas, and then rolled into a cold storage environment until needed (e.g., a rush of orders is received, and the pizzas/doughs are brought back out to be prepared and/or baked).

In a kitchen environment having automated aspects, e.g., which use robots or the like to assemble or bake a food item, there is a continuing desire to locate particular racks and/or their contents for interfacing with automated equipment. For example, as noted above an automated pizza system may require information on what is in the rack (e.g., what topping(s) are on pizzas/doughs in the rack), or information about a location of different racks in a system. In various examples herein, sensors may be used to determine a location of a rack and/or contents of a rack and/or bays within a given rack relative to automated components such as robot arm.

While the examples herein are provided in the context of an automated pizza/dough system, concepts herein may be applied in the context of any food, automated food preparation equipment, or equipment holding rack that is convenient. As described herein, racks may be configured in a modular manner such that they may be readily transported by a human operator and/or an automated drive of the rack itself or other device (e.g., an automated guided vehicle) for temporary storage, staging, and the like.

Generally, example approaches herein may be directed to a storage system, e.g., for a kitchen environment. Example storage systems may have one or more mobile racks that may be used with a temporarily or permanently stationary frame. As will be described further below, a kitchen environment may include equipment or components for processing food ingredients such as ovens, assembly stations, or the like. In some examples, food equipment may be utilized to produce food items, e.g., pizzas, in response to orders received from one or more customers. Example systems may also employ a variety of automated equipment such as one or more robot arms, automated conveyors, pickers, or bins, and as such may automate at least some kitchen tasks. Merely as examples, a robot may be configured to move food ingredients from storage racks to an automated assembly device, to a manual topping assembly station, and/or to an oven for cooking. As described herein, a mobile rack may be attached or otherwise situated relative to a frame, which in turn is at a known position relative to a location of a robot arm, which in turn may be fixed or may be mobile such as along a track or on wheels. In either event, the relative location of the automated equipment such as the robot relative to the mobile rack is known, as are details about the contents of the mobile rack. Such a configuration allows for optimization of operations of an automated food preparation system and avoids the need to employ costly, complex, and time-consuming operations such as employing vision system to dynamically assess relative locations and rack contents.

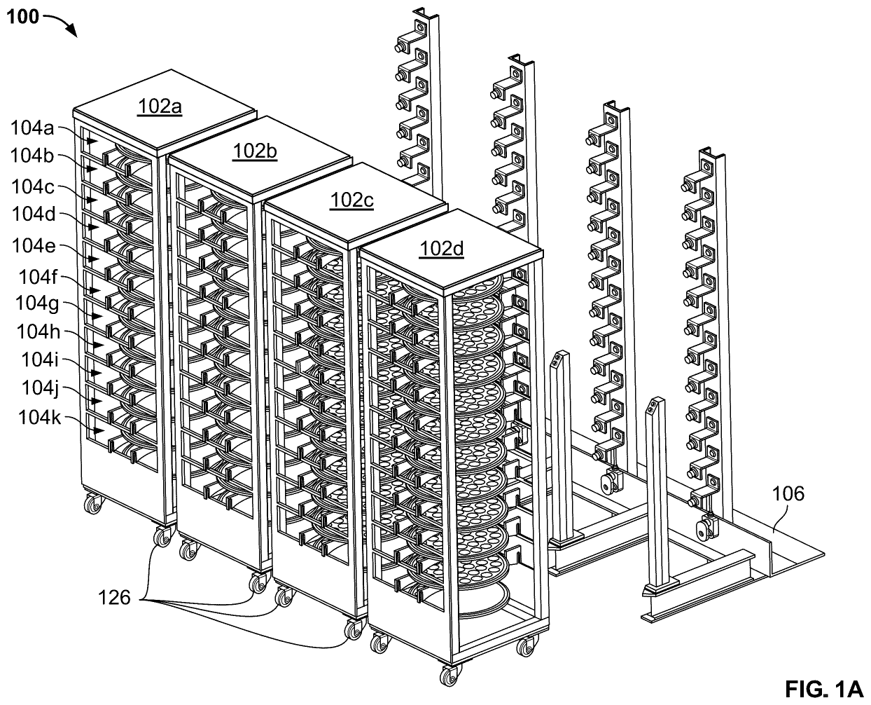

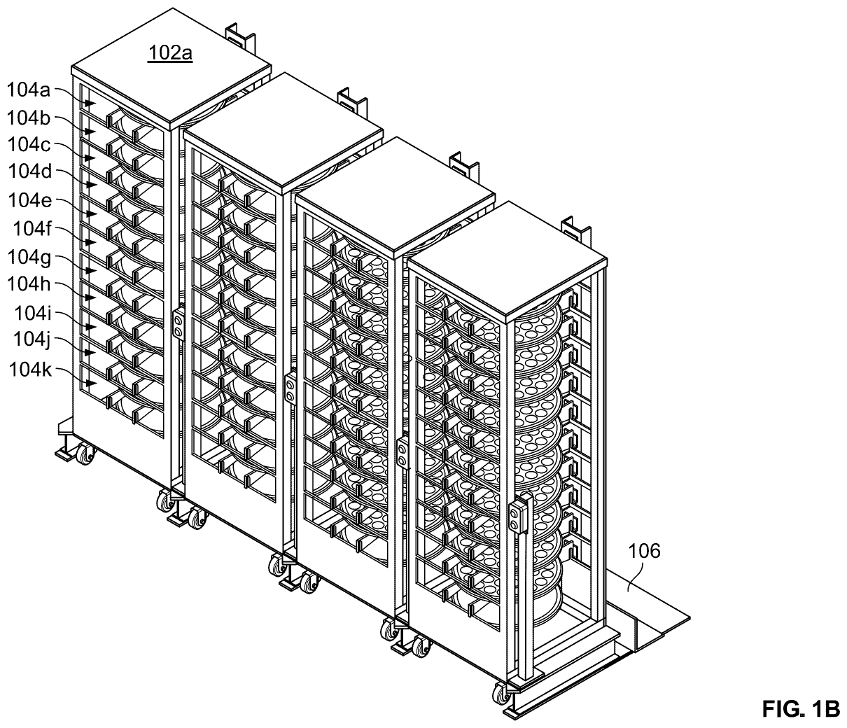

Referring now to FIGS. 1A and 1B, an example storage system 100 is illustrated and described in further detail. Generally, system 100 includes a stationary frame 106 with a plurality of mobile storage racks 102. The frame may be permanently stationary (e.g., fixed to a floor, utilities, or other equipment) or may be temporarily stationary at known locations. As will be described further below, the racks may be configured to be identified and/or located, e.g., by a processing device or controller of the kitchen environment. The frame may have sensors and other components configured to identify racks, locations of the racks, and contents of the racks. The frame may also have interfaces for the racks, such as to selectively provide power or other utilities (e.g., wired or wired data connections, heat, cooling, water, etc.).

FIG. 1A depicts a mobile rack system 100 for storing and/or transporting pans (or other similarly flat objects). The racks 102 may be mobile via any manner that is convenient. In the illustrated examples, wheels 126 are provided on a bottom of the racks 102 and may facilitate moving the mobile racks 102 along a floor surface. Merely as examples, the wheels 126 may be rotatable casters that allow the mobile racks 102 to be relatively freely pushed in any desired direction by a user and/or automated equipment such as a robotic arm. Further, the ability of the mobile racks 102 to be freely moved in any horizontal direction may facilitate movement of the racks 102 into storage positions such as will be described below with respect to the frame 106. The mobile racks 102 may each contain a plurality of bays 104. The number of bays present within a single rack can be modified by controlling a separation distance between bays 104 and an overall height of the rack 102 (i.e., taller racks yield more bays). These bays 104 are capable of storing relatively flat objects (e.g., pizza pans) in an orientation parallel to a floor surface supporting the rack 102. In this orientation, food items such as pizza doughs, assembled pizzas, or baked/ready-for-consumption pizzas may be provided on the pans. FIG. 1A depicts an exemplary embodiment where the system stores and transports pizza pans. The bays 104 of the mobile racks 102a and 102b are illustrated with empty pizza pans 102a-102b, while rack 102c is shown with assembled/uncooked pizza 102c in the bays 104 thereof, and rack 102d is provided with baked pizzas. Each of the racks 102 may contain a single type of food (e.g., unbaked doughs) or multiple types of food ingredients or ingredient types in its bays 104. As noted above, the racks 102 are mobile, e.g., as a result of the wheels 126, and as such it is possible to transport each individual rack 102 to a predetermined or desired location within a frame 106 for safe and secure storage (FIG. 1B).

In the illustrated example of FIGS. 1A and 1B there are four mobile racks 102a-102d. The number of mobile racks (i.e., ≥1) is only limited as to what is convenient for the end user and the size of the storage area, configuration of automated system in which the racks 102 are utilized, etc. The mobile racks 102 may be assembled from components formed of metal (e.g., steel, aluminum), composite, plastic, or any other suitable material that can support the weight of the objects within its respective bays 104, in addition to maintaining structural stability. It may also be desired to employ food-safe materials in the construction of the racks 102, to the extent this may facilitate sterilizing or cleanability of the racks 102. Similar to the number of racks, the number (i.e., ≥1) of bays 104 within each mobile rack 102 can vary and is only limited by the overall height of the mobile rack 102 and the distance between the bays 104. The volume/size of the bays 104 is dictated by the dimensions of the mobile rack 102, whereby larger dimensions may afford for larger objects to be stored within the bays 104. Each bay 104 is capable of storing its contents (e.g., pizza pans) in a relatively flat and planar manner (i.e., parallel to the floor), and may thereby be disposed to storage of relatively flat or planar food items such as pizzas or flatbreads. The content of the bays 104 can vary not only between racks 102, but also within the same rack 102. For example, a mobile rack 102 may only contain empty pizza pans, or dough, or uncooked pizza, or cooked pizza. The mobile racks 102 may also contain a combination of food ingredients/items within their bays 104 (e.g., even-numbered bays contain uncooked pizza, while odd-numbered bays contain cooked pizza, or bays in a lower end of the racks contain uncooked ingredients, while bays in a higher end of the racks contain cooked/completed ingredients).

Movement of the mobile racks 102 may be facilitated by wheels 126 attached to the bottom of the racks 102. Generally, square/rectangular mobile racks 102 may have four wheels affixed to an undercarriage of the racks 102. However, any number of wheels suitable for the rack configuration may be used. In some cases, wheels may be replaced by casters, rollers, disks, rings, gliders, or any other component that may facilitate rolling or sliding movement of the racks 102. Wheelsets may also be employed for compatibility with an in-house rail network within the storage area. In some examples, a locking mechanism (not shown) may be coupled to the wheels to prevent them from rotating. While FIG. 1A depicts a system that generally relies upon manual movement of the mobile racks 102 (i.e., pushed by a human operator), the means by which the racks 102 are transported are not limited to solely manual propulsion. In some embodiments the racks 102 may have a built-in battery and/or motor, and whose movements are guided with assistance from electronic circuits and sensors. In still other examples, an automated food system in which the storage system 100 is employed may have robots, robotic arms, or other automated equipment that may push or otherwise move racks 102.

Mobile racks 102 can be transported to predetermined storage locations within a stationary frame 106, which can hold one or many of the racks 102. Similar to the racks 102, the frame 106 may be fabricated from a metal material (e.g., steel, aluminum), composite, plastic, or any other suitable material. The frame 106 contains components (that will be discussed below) to help monitor presence of the racks 102 and ensure their stability/security within the storage areas of the frame 106. The frame 106 may be permanently stationary (e.g., affixed to a floor surface, wall, or other structure) or temporarily stationary (i.e., stationary during operation, but without formal attachment to surfaces or other structures). In some embodiments, the frame 106 may have wheels, casters, sliders, or the like attached to bottom surface to facilitate mobility and/or transport of the frame 106 between storage rooms/areas. Power or other utilities/accessories (e.g., electricity, water, gas, internet) may be connected to the frame 106 in order to enhance their functionality.

As shown in FIG. 1B, the mobile racks 102 may be located within docks or designated storage areas of the frame 106. In this position, the racks 102 may be locked in place relative to the frame 106 to prevent movement of the racks 102, e.g., to encourage stability of the racks while loading/unloading food items from the bays 104 of the racks. Additionally, as shown in FIG. 1B when in the storage position shown, all of the racks 102 are flush about a perimeter of the frame 106, or at least across one or more sides of the frame 106, thereby facilitating a relatively compact footprint within a storage system 100. For example, when positioned as shown in FIG. 1B, each individual rack 102 does not obstruct the reception or removal of another rack 102 from its respective dock or storage area. Note that the configurations shown are not limiting and other designs, sizes, and geometries may be employed for the convenience of the end user.

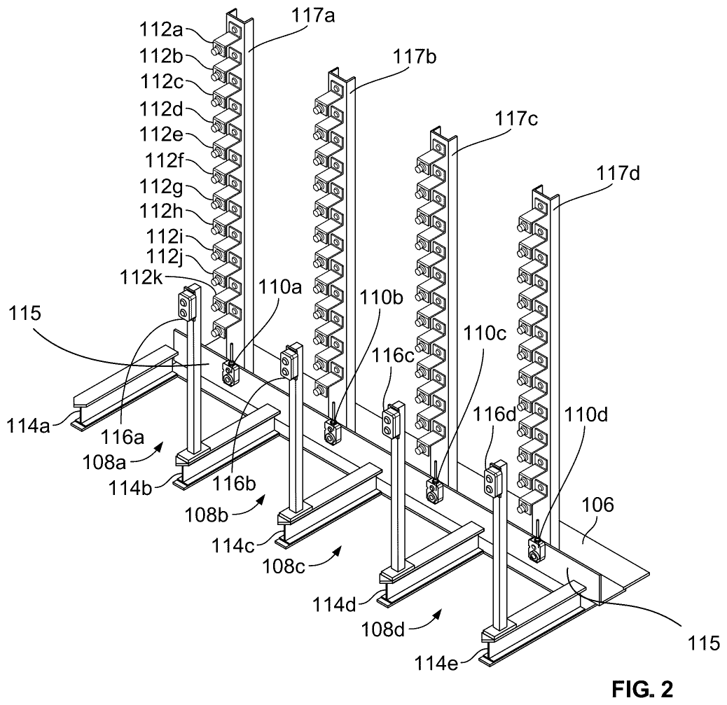

Referring now to FIG. 2, the frame 106 is illustrated and described in further detail. The frame 106 includes a plurality of docks 108a, 108b, 108c, and 108d (collectively, 108) configured to guide a respective one of the mobile racks 102 to a storage position within the dock 108 (i.e., as the racks 102 are shown in FIG. 1B). The docks 108 are generally defined by spaces between guide arms 114 of the frame 106. More specifically, the guide arms 114 extend unidirectionally away from a base 115. Each dock 108 is configured for holding a single mobile rack 102, although in other examples multiple racks 102 may be positioned in a single dock 108.

The frame 106 may be configured to reliably position the mobile storage racks 102 in a storage position with respect to the frame 106 (see FIG. 1B). For example, one or more locating features, datums, or the like may be employed to position the mobile racks in the docks 108 or other storage position with respect to the frame 106. In the illustrated example, the guide arms 114 generally ensure a consistent horizontal position of the storage rack 102 with respect to the frame 106 when the storage rack is in the storage position. More specifically, the guide arms 114 on either side of a dock 108 generally align the mobile rack (not shown in FIG. 2) in a horizontal direction within the dock 108. For example, when a rack 102 is moved toward a dock 108 of the frame, the rack 102 may come into contact with the guide arm 114. As the rack 102 is moved further into the dock 108, the guide arm 114 may delimit movement such that the rack 102 is moved into a position within the dock 108 where the lock 110 is positioned adjacent magnet 118. Accordingly, the rack 102 is generally aligned for locking in place with respect to the frame 106. In some examples, guide arms 114 on opposite sides of a rack 102 may cause the rack 102 to move in a single direction upon contact/engagement with both guide arms 114, thereby guiding further movement of the rack 102 as it is pushed deeper into the dock 108. The reliable/consistent positioning of the rack 102 may facilitate guidance of automated equipment, e.g., such that a controller or processor of the kitchen environment can communicate with a robot to facilitate movement/collection of food ingredients to/from the bays 104 of the storage racks 102. Additionally, the frame 106 may be configured to provide feedback or confirmation of an engagement of the storage rack in the dock, e.g., a visual indicator or light may activate in response to the storage rack being received in the dock.

The guide arms 114 and/or other parts of the frame 106 may act as conduits for any electrical signal paths, utility lines (e.g., electrical, gas, etc.), or additional sensors. Lengths of the arms 114 may vary and may be suited to a size of rack(s) that are to be stored within its respective dock 108. Increasing length of the arms 114, or spacing between the arms 114 enlarges area available within the docks 108 and may thereby accommodate larger mobile racks. While the illustration in FIG. 2 depicts a generally equal distance between arms 114 and generally quadrilateral-shaped docks 108, other embodiments may have arms with smaller or larger spacing and docks 108 with other shapes (e.g., partially hexagonal). Additionally, it should be noted that geometrical dimensions and configurations of the frame 106 may, in addition to those of the guide arms 114, influence shape and size of an available area within the dock 108, and thus may also determine a shape and maximum size of a mobile rack that can be stored within the dock 108.

Each dock may include a lock 110 configured to selectively prevent movement of the mobile rack 102 in the storage position. The locks 110 may include an electromagnetic lock or device located at the rear of the dock 108, e.g., on the base 115 of the frame 106. Upon interaction with, e.g., an unpowered magnet of the mobile rack (not shown in FIG. 2), the rack can be secured within the dock 108. For example, a button/lever located on a user interface 116 of each dock 108 can selectively actuate the lock 110, thereby locking or unlocking the mobile rack 102. When the lock 110 is actuated, the rack 102 is retained within a dock 108 and prevented from movement. When the lock 110 is deactivated or unlocked, the rack 102 may be free to be rolled away via the wheels 126, e.g., to another storage location, a refrigerator, etc.

Contents of the racks 102 may be monitored, e.g., when the racks 102 are positioned in their respective docks 108, through the use of bay sensors 112 that attached to a tower structure 117 mounted upon the base 115, adjacent the rear of the dock 108. As will be described further below, for each bay 104 located within the mobile rack, there may be provided a respective bay sensor 112 on the tower structure 117 that may determine if any object (e.g., pizza pan) is present within the bay 104. An indicator light 124 may also be located near the bay sensor 112 to optically inform the operator of the sensor's output (e.g., a red light indicates pan is present, while green light indicates available space).

The locks 110 may be powered via electrical pathways present within the frame 106 (not shown) and may be independently controlled through its respective user interface 116, which determines whether the locking mechanism receives power or not (i.e., lock is powered/active or depowered/inactive). As will be discussed further below, whenever a storage rack (not shown in FIG. 2) is located within the dock 108, an unpowered magnet located at the lower lateral edge of the mobile rack 102 interacts with its respective electromagnetic lock 110 to secure the rack 102 in place. The lock 110 may thereby be user-controlled and actuated via each dock's dedicated user interface 116. The user interface 116 rests atop a post or other structure located on the top surface of the arms 114, thereby positioning the user interface 116 at a convenient height for actuation by a user. Note that certain frame configurations may result in one or more arms 114a, especially those near edges, not having a user interface 116 and/or user interface support structure affixed to its top surface (as illustrated in FIG. 2). The user interfaces 116 may receive power via electrical pathways present within the arm 114 Controls of the user interface 116 may be, but are not limited to, buttons, levels, knobs, handles, dial, switches, or digital touch screens. In some embodiments, indicator lights may exist near the electromagnetic lock 110 and/or the user interface 116 to optically inform the operator of the lock state of the mobile rack (i.e., green indicates unlocked, while red indicates locked).

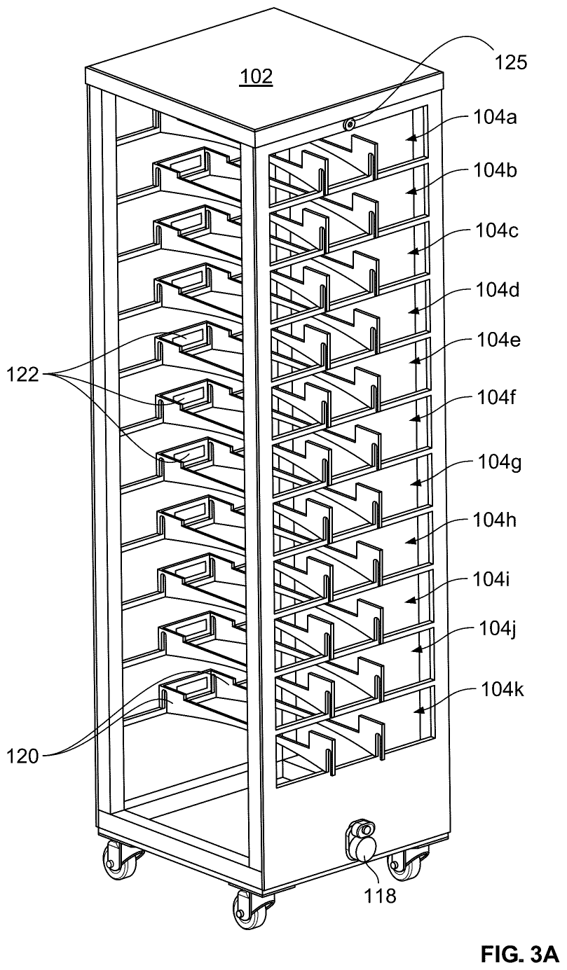

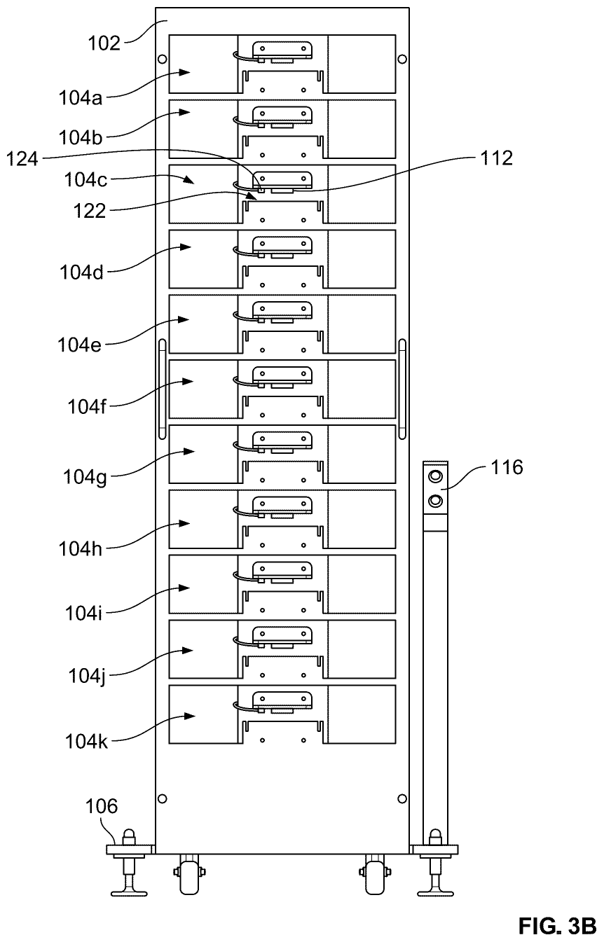

As noted above, sensor(s) positioned on the frame 106 or otherwise in a kitchen environment may facilitate detection and/or identification of food ingredients stored in bays of storage racks. For example, the frame 106 may be provided with sensors corresponding to each of bays of the storage racks, such that each sensor corresponds to a different respective bay of the mobile rack. As illustrated in FIG. 2, each dock 108 is provided a set of bay sensors 112 extending vertically along a respective tower structure 117 that are capable of determining if any object (e.g., pizza pan) is present within a bay 104 (not shown in FIG. 2) adjacent the bay sensors 112, respectively. The bay sensors 112 may receive power and signals (e.g., from the user interface 116) via electrical pathways present within the frame 106 and tower structure 117. While FIG. 2 depicts an embodiment utilizing only one optical sensor for each bay that merely detect the presence of an object, other embodiments may employ different or additional sensors (e.g., proximity, infrared, ultrasonic, capacitive) to identify a presence of objects, types of objects, or other desired aspects of a corresponding bay of a rack. For example, temperature sensors may be able to determine if a food ingredient in a bay of a rack is uncooked (i.e., room temperature) or cooked (i.e., elevated temperature), or may track temperature over time. Bay sensor type configurations can vary between frames 106, within the same frame 106 (e.g., dock 108a utilizes optical sensors, while dock 108b utilizes temperature sensors), or within the same dock, whereby bay sensors 112a-112e may utilize optical sensors, while bay sensors 112f-112k may utilize temperature sensors. In an example, the bay sensors 112 are optical sensors that project light and measure a reflected amount of light to determine absence/presence of food items such as a pizza, flatbread, or other objects in each bay 104. Alternatively, bay sensors 112 may be inductive or capacitive sensors, merely as examples. A geometrical and spatial configuration of the bay sensors 112 can be adjusted in order to match the size/shape of the docked mobile rack, e.g., a separation distance between each bay 104 of racks 102. An indicator light 124 (see FIG. 3B) may also be located near the bay sensor 112 to optically inform the operator of the sensor's output (e.g., a red light indicates pan is present, while green light indicates available space). In some examples, the frame 106 may also include a rack sensor configured to determine a location of one or more of the mobile racks with respect to the frame 106. As discussed above, the frame 106 may be configured with a lock 110 configured to securely hold the mobile rack when positioned in the dock 108, e.g., in a storage position. The lock 110 may be engaged in response to a detection of a position of the rack within the dock 108, and engagement of the lock 110 may provide an indication to a controller or processor of the kitchen environment that the rack is engaged with the frame and/or dock in a storage position. Accordingly, automated equipment of the kitchen environment such as a robot arm may be used to retrieve food ingredients from the storage rack, place food ingredients in bays 104 of the rack 102, etc. Further, bay sensors 112 may be employed to inventory racks, e.g., by detecting a presence and/or type of food ingredient within bay(s) of the racks. Accordingly, a controller or processor of the kitchen environment may track inventory of necessary food ingredients, e.g., to determine whether additional pizza/dough will be needed to fulfill an order.

In some implementations, positions of the sensors 112 may be mechanically and/or electromechanically adjustable, e.g., along the tower structures 117, to provide sensor functionality for a variety of rack sizes and implementations. The bay sensors 112 may each detect information about a food item, such as whether or not a dough or pizza is located in one of the bays on the rack. In an example, the bay sensors 112 are each an optical sensor which may detect whether a dough or pizza is present within the adjacent bay of the storage rack by the breaking/unbreaking of a reflected beam of light. Other sensors such capacitive, proximity, infrared, ultrasonic, or the like may perform a detection function. Other sensor types may be used to assess additional information about the food items, such as a food item or pizza size, whether a pizza has been prepared (e.g., based on the presence of toppings), whether a pizza has been cooked (e.g., temperature sensors). Information from multiple sensors may be combined and/or other information (e.g., timers) may be employed to assess the status of items in bays or other holding compartments of a rack.

In some examples, the frame 106 may be configured to determine an identity and/or location of one or more of the rack 102, which in turn may have information about the rack 102 and its contents electronically tracked throughout the food preparation environment. Racks, for example, may carry a tag or other identifier, e.g., a machine-readable tag such as an RFID tag, which may be read by a rack sensor of the frame 106 to determine contents of the storage rack 102. In some examples, a machine-readable tag of the rack is configured to be sensed by a rack sensor of the frame 106 within a predetermined proximity distance of the rack 102, such that proximity of the rack 102 within a certain distance of the frame, e.g., within a few feet, allows a controller/processor of the frame 106 and/or system 100 to determine contents of storage rack(s) nearby. For example, as illustrated in FIG. 3A, RFID tag 125 may be provided at an upper end of the rack 102. A corresponding module (not shown in FIG. 3A) in communication with a system controller may be provided on the frame 106 that is configured to be positioned adjacent the RFID tag 125 when the rack 102 is positioned in a dock 108 of the frame 106. Accordingly, the frame module and/or a system controller may be configured to read information stored on the RFID tag 125, to update or revise the information, etc. In this manner, the RFID tag 125 may facilitate tracking of contents of the racks 102 and/or one or more bays 104. While the RFID tag 125 is illustrated along an upper portion of the rack 102, the RFID tag 125 may be positioned anywhere else on the rack 102 that is convenient.

Referring now to FIGS. 3A and 3B, mobile rack 102 is illustrated and described in further detail. Each bay 104, which as noted above may be used to store any planar object (e.g., pizza pans), may be defined in part by pairs of pan supports 120. Pan supports 120 extend laterally across the rack 102, and may be rigid to allow pans or other flat or planar structures to sit upon the pan support 120. The presence of an object within a bay 104 may be determined by its respective bay sensor located at the rear of the dock on the frame. The sensor emits an optical signal (e.g., infrared) and depending on the amount of reflected light that is detected, information may be gathered regarding the presence of an object. For example, if a pizza pan is not present within the bay 104, the emitted light waves will fully reflect off the bay's respective reflector 122 and be detected by the optical sensor. As the amount of emitted light would be close to the amount of detected light, the optical sensor would output that no object is present within the bay 104. The entire rack 102a can be secured within its dock via the magnet 118 located at the bottom lateral edge of the mobile device. Upon interaction with the electromagnetic lock located on the frame of the storage framework, the rack 102 may be locked in place until the operator manually unlocks the rack via its user interface.

As noted above, racks 102 may have a magnet 118 or other device for interfacing with locks 110 of the frame 106 (not shown in FIGS. 3A or 3B). The magnet 118 may be positioned on a bottom lateral edge of the mobile rack 102. The magnet 118 may be unpowered and may vary in size, shape (e.g., rectangular), and magnetic composition/strength. Upon coming into proximity to an active electromagnetic lock 110, the two components are drawn together, thus securing the entire mobile rack 102 in place against the lock 110, with the rack 102 positioned within the dock 108. While FIG. 3A depicts an embodiment with a singular circular magnet in a particular location, other embodiments may have one or more additional magnets, or single/multiple magnets with different shapes or in other locations. Further, some magnets 118 may have an adjacent plug, coupler, or other interface device for the frame 106 (not shown) that may provide power to the rack 102 when it is docked to the frame 106.

Objects within the bays 104 are supported by pan supports 120, as noted above. While denoted as “pan supports,” they are capable of supporting any relatively flat and planar object. A size, shape, number, geometry, and construction material of the pan supports 120 may be selected based on what is most convenient for a particular size of rack 102 and/or bays 104. The pan supports 120 may be anchored to the rack 102 in such a way to ensure that objects supported by the pan supports 120 are kept relatively close to level. Some configurations may slightly tilt the pan supports 120 towards the rear of the rack 102, e.g., to better secure the object within its respective bay 104.

As best seen in FIG. 3A, which is a rear view of the rack 102, a reflector 122 may be mounted to a front panel 123 of the rack 102. The reflector 122 may reflect an optical signal from the bay sensor 112 adjacent the bay 104, respectively (e.g., to assist in detecting when an object is present within the bay 104). When the rack 102 is secured within dock 108 to the frame 106, the bay sensor 112 attached to the frame 106 may emit a beam of light, infrared signal, or other optical signal. Depending on an amount of reflected light that is detected by the bay sensor 112, a presence of an object in the bay 104 may be determined. For example, if a pizza pan is not present within the bay 104, the emitted light waves will fully reflect off the bay's respective reflector 122 and be detected by the optical sensor 112. As the amount of emitted light would be close to the amount of detected light, the bay sensor 112 would thereby provide a signal that no object is present within the bay 104. The size, number, geometry, and overall configuration of the reflector 122 can vary between racks 102 and bays 104 (e.g., bay 104a may use a narrow rectangular reflector, while bay 104b may use an elongated ovular reflector), depending on intended uses for the respective bay 104, e.g., types of objects intended to be detected.

In the example rack 102 illustrated in FIGS. 3A and 3B, the rack 102 is generally unpowered, i.e., with components corresponding to the rack and identification of contents of the rack 102 that require electrical power being carried by the frame 106 or otherwise “offboard” with respect to the rack 102. In this manner, it is not necessary for the rack 102 to carry wiring, batteries, or other electrical equipment, and simplifies overall construction and cost of the rack 102. Rather, electrical components such as the bay sensors 112 are carried by the stationary frame 106, with the storage racks 102 having corresponding passive components, e.g., reflectors 122, or RFID tags, which may be read by components of the frame 106. Accordingly, electrically powered components of the system 100 may be entirely supported on the stationary frame 106, racks 102 carrying passive components that do not require an independent power source on the rack 102, and which interface with the powered components on the frame 106.

While the illustrated example racks 102 in FIGS. 3A and 3B are unpowered as described above, in other alternative approaches the racks 102 may have one or more powered components, e.g., which may connect to power via the frame 106 when the rack 102 is in a dock 108 of the frame 106, or in another storage position. In such examples, the rack 102 may be provided with a plug or other interface that mates with a corresponding connector to the frame 106, with the frame 106 providing electrical power and/or other utilities to the rack 102 and/or components thereof by way of the plug/interface. For example, the rack may have a power plug configured to engage with a powered receptacle on the frame 106 when docked, to provide power to components of the rack 102.

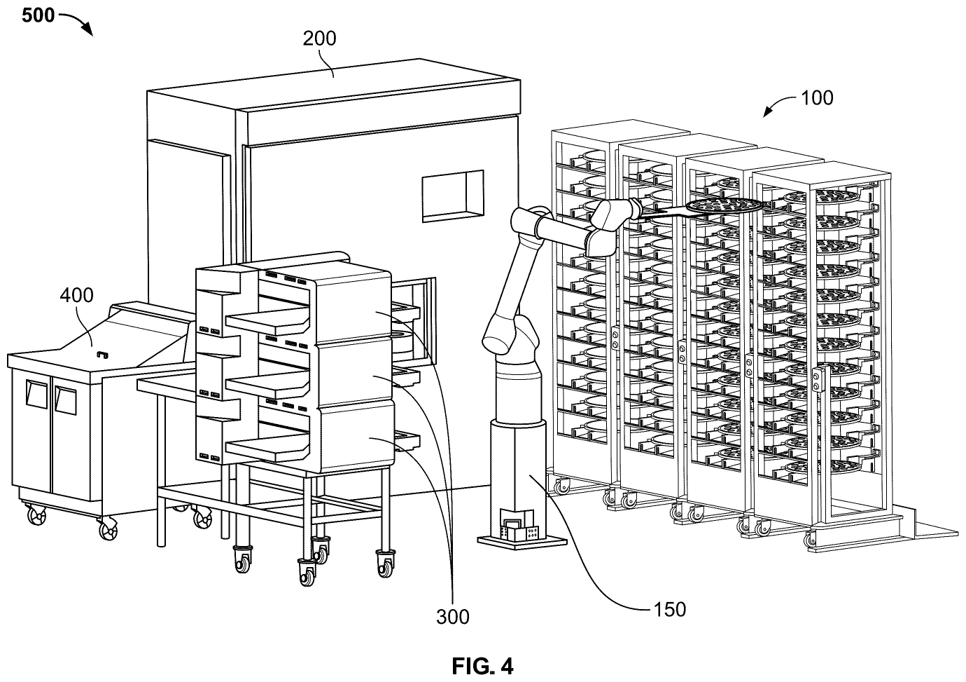

Referring now to FIG. 4, an exemplary kitchen environment 500 is illustrated utilizing the mobile sensorized rack system 100. In some embodiments, uncooked pizza dough may be located within bays 104 of one or more racks 102. After a customer provides an order for a pizza, a robotic arm 150 can remove a pizza pan containing the dough from a particular rack 102 and transfer it to the automated pizza assembly system 200.

The pizza assembly station 200 is a robotic device that is capable of preparing all the necessary ingredients (excluding the dough) for a pizza. Once uncooked pizza dough arrives at the station, the robot can add a variety of ingredients ranging from sauces and mixtures to cheeses and toppings (e.g., vegetables, meats, fish). The station may be configured to any size or geometry depending on what is most convenient for the operator. The pizza assembly system 200 may be a PizzaBot or other pizza assembly system configured to sauce, cheese, and/or one or more toppings to the dough (customizable per the customer's request).

The robotic arm 150 may transfer the assembled, uncooked pizza to the triple oven system 300 to bake at a specific temperature. The three-oven system 300 may bake multiple pizzas at a time. The type of oven may vary (wood-fire, gas, electric) between not only kitchen environments 500, but also within the same triple oven system 300 (e.g., one of the three ovens is gas, while the other 2 are electric). The baking temperature and duration may vary between the three ovens of the system in order to accommodate different pizzas (e.g., deep dish vs. thin crust). Included within the ovens may be a conveyor belt or rotation device to ensure uniform baking of the pizza and/or transport from one end of the oven to the other.

Once the pizza(s) is/are cooked, the robotic arm 150 may then transfer the pizza to a finishing station 400, e.g., for the addition of any last toppings/ingredients (e.g., sauces, spices, herbs) and/or to be packaged for delivery to the customer. The assembly station may, at least in some examples, be a final assembly point within the kitchen environment 500. The station may include robotic devices and/or devices that require human manipulation. Cooked pizzas that arrive here can receive any remaining sauces, herbs, spices, and dough flavorings. In some embodiments, this station can also prepare the pizza for serving (on a plate) or for transport to the customer (in a pizza box).

The configuration of the kitchen environment 500 can vary from the illustrated example depending on the size of the room and the needs of the operator. For examples, a distance between the different apparatuses can be adjusted and the total number of apparatuses can be modified (e.g., two triple oven systems and 3 mobile rack units). The different units may be stationary (e.g., affixed to the floor) or mobile whereby all apparatuses contain wheels on the bottom.

Additionally, it should be noted that pizzas, doughs and other ingredients may be processed differently in other example approaches than as described above. Merely as one example, assembled and/or baked pizzas may be stored in bays 104 of one or more of the racks 102 for later retrieval by a customer, rather than being packaged at finishing station 400.

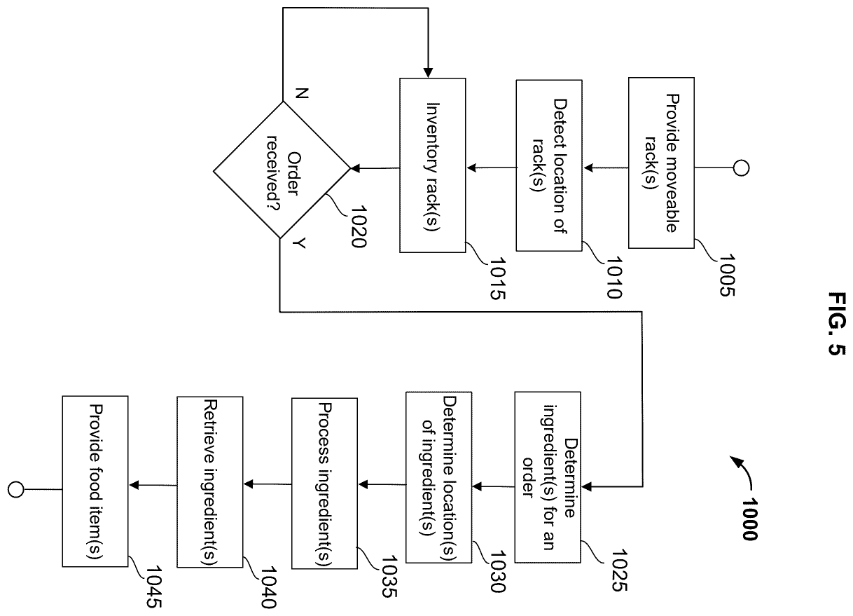

Referring now to FIG. 5, an example process 1000 of storing food ingredients is illustrated and described in further detail. Process 1000 may begin at block 1005, where a plurality of mobile racks are provided. For example, as discussed above one or more racks 102 may be provided, with each rack 102 comprising a plurality of bays 104. Process 1000 may then proceed to block 1010.

At block 1010, a location of one of the mobile racks may be detected in a storage position of a frame. For example, as discussed above, racks 102 may be configured to be secured within a dock 108 of the frame 106. The frame 106 may have one or more locks 110 that are configured to secure a rack 102 in a generally stationary horizontal position with respect to the frame 106.

As also discussed above, the frame 106 may include a plurality of docks 108, each configured to guide the one of the mobile racks 102 to the storage position in the dock 108. The frame 106 may also include a lock configured to selectively prevent movement of the one of the mobile racks 102 in the storage position. Additionally, the frame 106 may include a plurality of bay sensors for each dock. For example, bay sensors 112 may be optical sensors configured to detect a presence of a food ingredient stored in bays 104 of the mobile rack 102 when the mobile rack is in the storage position, i.e., when positioned in the dock 108 and locked in place using the lock 110.

Proceeding to block 1015, process 1000 may inventory any racks 102 that are present in the storage system. For example, as noted above sensors may be provided that are configured to determine a presence of contents within bay(s) 104 of racks 102. Information regarding contents of a rack 102 may also be obtained from information tags, e.g., RFID tags or the like, which are locally stored on each rack 102.

At block 1020, process 1000 may query whether an order has been received. Where process 1000 determines that an order has not been received, process 1000 may proceed back to block 1015 to inventory racks 102 present in the system, thereby continuously monitoring for changes in inventory of food ingredients. Alternatively, where an order is received, process 1000 proceeds to block 1025.

At block 1025, process 1000 may determine one or more ingredients needed to satisfy the received order(s). For example, process 1000 may determine a number of pizza doughs required. Process 1000 may then proceed to block 1030.

At block 1030, process 1000 may determine a location of the ingredients or food items needed to satisfy the order. For example, process 1000 may determine a particular rack 102 and/or bay(s) 104 containing the ingredients required for the order, e.g., pizza doughs. Proceeding to block 1035, process 1000 may retrieve the ingredients, and at block 1040 may initiate processing of the ingredients, e.g., to apply toppings to the doughs, and/or to bake the pizzas.

Proceeding to block 1045, process 1000 may provide completed food items to satisfy the order. For example, robot arm 150 may retrieve one or more completed pizzas and position them in racks 102 for customer retrieval.

Although the examples herein are specifically addressed to pizza preparation, the modular nature of the example racks and storage systems allow implementation in a wide range of racked food items or other products. This flexibility makes the mobile sensorized racks suitable for various culinary applications, from baking pastries to assembling sandwiches, thereby broadening their usability in commercial kitchens.

Example storage racks and systems are generally modular, e.g., by allowing scaling from a single rack to multiple racks, multiple frames, etc. as needed. This expansion capability allows kitchens to adapt to varying demands without overhauling an existing food or storage system setup. As operational needs change, additional racks and/or frames can be seamlessly integrated into the system.

The specific sensors described for rack retention and product identification are not exhaustive. The system can accommodate a variety of sensors and components, allowing for customization based on particular kitchen needs or food types. This adaptability ensures that the mobile racks can evolve alongside technological advancements and changing culinary trends.

In summary, mobile sensorized racks herein may provide an innovative solution for enhancing operational efficiency in commercial kitchens. Their integration of advanced technology, versatility, and scalability makes them a valuable asset for any automated food preparation system.

The foregoing is merely illustrative of the principles of this disclosure and various modifications may be made by those skilled in the art without departing from the scope of this disclosure. For example, while the kitchen environment is generally directed to production of pizza/dough, example systems may be employed in the context of any other racked food or item. Additionally, while the storage system is illustrated with a frame configured to receive four storage racks, example systems may be configured with any number of docks, racks, bays within the docks, etc., as may be convenient. As such, the example storage systems described herein are modular and expandable to any number of racks, frames, bays, etc. that is convenient. Furthermore, while specific sensors are described above for retaining the racks and for identification of racks, bays, and food ingredients, example systems are not limited to the particular sensors, sensor types, or components described herein. Accordingly, the embodiments described herein are provided for purposes of illustration and not of limitation. Thus, this disclosure is not limited to the explicitly disclosed systems, devices, apparatuses, components, and methods, and instead includes variations to and modifications thereof, which are within the spirit of the attached claims.

The systems, devices, apparatuses, components, and methods described herein may be modified or varied to optimize the systems, devices, apparatuses, components, and methods. Moreover, it will be understood that the systems, devices, apparatuses, components, and methods may have many applications. The disclosed subject matter should not be limited to any single embodiment described herein, but rather should be construed according to the claims.

What is claimed is:

1. A storage system, comprising:
a plurality of mobile racks, the racks each comprising a plurality of bays; and
a frame, comprising:
a plurality of docks, each dock configured to guide one of the mobile racks to a storage position in the dock;
a lock configured to selectively prevent movement of the one of the mobile racks in the storage position; and
a plurality of bay sensors for each dock, the bay sensors configured to detect a presence of a food ingredient stored in the bays of the one of the mobile racks when the one of the mobile racks is in the storage position.

2. The storage system of claim 1, wherein the frame comprises a visual indicator in communication with one of the bay sensors, the visual indicator configured to indicate a presence of the food ingredient.

3. The storage system of claim 1, wherein the lock comprises an electromagnet.

4. The storage system of claim 3, wherein the frame comprises a user interface configured to actuate the electromagnet.

5. The storage system of claim 3, wherein each of the mobile racks comprises a magnet configured to interface with the electromagnet.

6. The storage system of claim 1, wherein at least one of the docks comprises a guide configured to align the mobile rack in a horizontal direction within the dock.

7. The storage system of claim 1, wherein each of the plurality of bay sensors corresponds to a different respective bay of the mobile rack.

8. The storage system of claim 1, wherein the frame comprises a rack sensor configured to determine a location of one or more of the mobile racks with respect to the frame.

9. The storage system of claim 1, wherein each of the mobile racks comprises a machine-readable tag configured to identify the rack within a predetermined proximity distance of the rack.

10. The storage system of claim 9, wherein the machine-readable tag comprises a radio frequency identification (RFID) tag.

11. The storage system of claim 1, wherein each of the mobile racks are unpowered.

12. A frame for retaining mobile racks, the racks each comprising a plurality of bays, comprising:
a plurality of docks configured to guide one of the mobile racks to a storage position in the dock;
a lock configured to selectively prevent movement of the one of the mobile racks in the storage position; and
a plurality of bay sensors for each dock, the bay sensors configured to detect a presence of a food ingredient stored in the bays of the one of the mobile racks when the one of the mobile racks is in the storage position.

13. The frame of claim 12, further comprising a visual indicator in communication with the bay sensor, the visual indicator configured to indicate a presence of the food ingredient.

14. The frame of claim 12, wherein the lock comprises an electromagnet.

15. The frame of claim 14, further comprising a user interface configured to actuate the electromagnet.

16. The frame of claim 12, wherein at least one of the docks comprises a guide configured to align the mobile rack in a horizontal direction within the dock.

17. The frame of claim 12, wherein each of the plurality of bay sensors corresponds to a different respective bay of the mobile rack.

18. The frame of claim 12, further comprising a rack sensor configured to determine a location of one or more of the mobile racks with respect to the frame.

19. The frame of claim 18, wherein the rack sensor is configured to detect a presence of a radio frequency identification (RFID) tag carried by the one or more of the mobile racks.

20. A method of storing food ingredients, comprising:
providing a plurality of mobile racks, the racks each comprising a plurality of bays; and
detecting a location of one of the mobile racks in a storage position of a frame;
wherein the frame comprises:
a plurality of docks, each configured to guide the one of the mobile racks to the storage position in the dock;
a lock configured to selectively prevent movement of the one of the mobile racks in the storage position; and
a plurality of bay sensors for each dock, the bay sensors configured to detect a presence of a food ingredient stored in the bays of the mobile rack when the mobile rack is in the storage position.
